(19) United States
(12) Patent Application Publication
(10) Pub. No.: US 2026/0249899 A1
(43) Pub. Date: Aug. 27, 2026

(54) STEER-BY-WIRE ASSEMBLY, METHOD, AND ABSOLUTE POSITION SENSOR THEREOF

(71) Applicant: Chassis Autonomy SBA AB, Trollhättan (SE)

(72) Inventors: Thomas Li, London (GB); Danilo Rojas

(21) Appl. No.: 19/489,694

(22) PCT Filed: Jun. 4, 2024
(86) PCT No.: PCT/SE2024/050547

§ 371 Date: Dec. 3, 2025

(30) Foreign Application Priority Data
Jun. 5, 2023 (SE) 2330264-9

(51) Int. Cl. B62D 5/00; B60K 35/22; B60R 16/023; B60R 21/203; B62D 1/06; B62D 1/08; B62D 1/16; B62D 15/02

(52) U.S. Cl. CPC B62D 5/006; B60R 16/0232; B62D 1/06; B62D 1/08; B62D 1/16; B62D 15/0215; B60K 35/22; B60R 21/203

(57) ABSTRACT

A steer-by-wire assembly, method and absolute position sensor for a vehicle, comprises a first motor with a stator and a rotor, a screw actuator configured to engage a threaded portion of a steering shaft and move the steering shaft longitudinally when the screw actuator rotates, and a rotor carrier sleeve coupled between the first rotor and the screw actuator, configured to rotate about the longitudinal axis of the steering shaft. The assembly also includes a first rotary position target arranged around the rotor carrier sleeve, wherein the position of the first rotary position target corresponds to a unique position of the steering shaft, and a first rotary position sensor configured to detect movement of the first rotary position target and send a sensor signal to a controller.

### CROSS REFERENCE TO RELATED APPLICATIONS

This application claims priority to International Application No. PCT/SE2024/050547, filed Jun. 4, 2024, which claims priority to Sweden Application No. 2330264-9 filed Jun. 5, 2023, the contents of both of which are incorporated herein by reference in their entirety.

### FIELD

The technology relates to the field of automotive engineering, specifically to steering systems for vehicles and in particular steer-by-wire assemblies.

### BACKGROUND

In recent years, there has been a growing interest in the development of autonomous vehicles, which are capable of navigating and operating without direct human intervention. One of the key components of an autonomous vehicle is the steering system, which is responsible for controlling the direction of the vehicle. Traditional steering systems typically include a steering wheel, a steering column, and a mechanical linkage connecting the steering wheel to the vehicle's wheels. However, in autonomous vehicles, the steering wheel may be eliminated, and the steering system may be controlled electronically by a vehicle control unit (VCU) through a steer-by-wire assembly.

Steer-by-wire assemblies are known in the art and generally comprise a motor assembly that provides rotation to a screw actuator, which in turn moves a steering shaft along its longitudinal axis. The steering shaft is connected to the vehicle's wheels via tie rods, and its position determines the direction of the vehicle. In order to accurately control the steering system, it is essential to know the absolute position of the steering shaft.

Various methods and devices have been proposed for measuring the position of a steering shaft in a vehicle. For example, U.S. Pat. No. 5,930,905 discloses a method and a device for measuring the angle of a steering column of a vehicle. The steering column cooperates with two gear wheels, whose angular positions are determined with the aid of two sensors. The angular position of the steering column is determined from the angular positions detected by the two sensors.

However, the prior art devices and methods have several shortcomings. One of the main problems is that they are designed to measure the angle of a steering column, which is not applicable to autonomous vehicles without a steering wheel. Moreover, the prior art devices are typically arranged adjacent to the steering column, which can be easily accommodated in the cabin of a vehicle. In contrast, the space constraints in an autonomous vehicle without a steering wheel make it difficult to accommodate the prior art devices in a compact arrangement.

### SUMMARY

In a first aspect, the disclosure provides a steer-by-wire assembly comprising a first motor with a first stator and a first rotor, a screw actuator configured to engage a threaded portion of a steering shaft and to move the steering shaft longitudinally when the screw actuator rotates, and a rotor carrier sleeve coupled between the first rotor and the screw actuator and configured to rotate about the longitudinal axis of the steering shaft. The assembly also includes a first rotary position target arranged around the rotor carrier sleeve, wherein the position of the first rotary position target corresponds to a unique position of the steering shaft, and a first rotary position sensor configured to detect movement of the first rotary position target and send a sensor signal to a controller.

In an optional example, the assembly further comprises a first sensor gearing configured to rotatably engage the rotor carrier sleeve and the first rotary position target, providing a gear reduction so that the first rotary position target rotates less than the rotor carrier sleeve.

The first rotary position target may be configured to rotate less than 360 degrees when the steering shaft moves from a first wheel lock position to a second wheel lock position.

In another optional example, the assembly further comprises a second rotary position target arranged around the rotor carrier sleeve, wherein the position of the second rotary position target together with the position of the first rotary position target corresponds to a unique position of the steering shaft.

The assembly may also include a second rotary position sensor configured to detect movement of the second rotary position target and send a sensor signal to the controller.

In yet another optional example, the assembly further comprises a second sensor gearing configured to rotatably engage the rotor carrier sleeve and the second rotary position target, providing a gear reduction so that the second rotary position target rotates less than the rotor carrier sleeve.

The gearing of the second sensor gearing may be different from the gearing of the first sensor gearing.

Optionally, the first sensor gearing comprises a first prime number of teeth and the second sensor gearing comprises a second prime number of teeth, different from the first prime number of teeth. The product of the first prime number of teeth and the second prime number of teeth is higher than the total amount of rotations required by the screw actuator for a whole stroke of the steering shaft from a first wheel lock position to a second wheel lock position.

In some examples, the assembly may further comprise a second motor having a second stator and a second rotor, wherein the second motor is configured to provide additional rotation to the screw actuator to move the steering shaft along the longitudinal axis.

Optionally, the screw actuator is selected from the group consisting of a ball screw actuator and a roller screw actuator.

Optionally, the first rotary position sensor and/or the second rotary position sensor are selected from the group consisting of an optical encoder, a magnetic encoder, an inductive encoder, a capacitive encoder, a Hall effect sensor, a resolver, a potentiometer encoder, and a cam follower.

Optionally, the first rotary position target and/or the second rotary position target are selected from the group consisting of a magnetic encoder, a patterned disc, a coded disc, a grating disc, a retroreflector disc, a slotted disc, and a Vernier scale disc.

Optionally, the first sensor gearing and/or the second sensor gearing are selected from the group consisting of epicyclic gears, harmonic gears, spur gears, bevel gears, worm gears.

Optionally, the controller is configured to determine the absolute position of the steering shaft based on the received sensor signals from the first rotary position sensor and/or the second rotary position sensor using a look-up table stored in memory.

Optionally, the controller is further configured to determine the absolute position of the steering shaft based on a detected unique rotary position of both the first rotary position target and the second rotary position target using the Vernier principle when signals are received from both the first rotary position sensor and the second rotary position sensor.

Optionally, the controller is further configured to determine the absolute position of the steering shaft based on the detected unique angular position of the first rotary position target when only the signal from the first rotary position sensor is used.

Optionally the first rotary position target and/or the second rotary position target is circumferentially arranged around the rotor carrier sleeve.

In a second aspect of the disclosure there is also provided a method of determining the absolute position of a steering shaft in a steer-by-wire assembly including a first motor having a first stator and a first rotor, a screw actuator configured to engage a threaded portion of a steering shaft and to move the steering shaft longitudinally when the screw actuator rotates, and a rotor carrier sleeve coupled between the first rotor and the screw actuator and configured to rotate about the longitudinal axis of the steering shaft; the method comprising detecting the position of the first rotary position target with the first rotary position sensor wherein the position of the first rotary position target corresponds to a unique position of the steering shaft, receiving at the controller the detected sensor signal from the first rotary position sensor, and determining the absolute steering shaft position based on the received sensor signal from the first rotary position sensor.

In an optional example, the method further comprises detecting the position of the second rotary position target with the second rotary position sensor, receiving at the controller the detected sensor signal from the second rotary position sensor, and determining the absolute steering shaft position based on the detected unique positions of both the first rotary position target and the second rotary position target using the Vernier principle.

Finally, in another aspect of the disclosure there is provided an absolute position sensor for a steer-by-wire assembly, including a first motor having a first stator and a first rotor, a screw actuator configured to engage a threaded portion of a steering shaft and to move the steering shaft longitudinally when the screw actuator rotates, and a rotor carrier sleeve coupled between the first rotor and the screw actuator and configured to rotate about the longitudinal axis of the steering shaft, the absolute position sensor comprising a first rotary position target arranged around a rotor carrier sleeve coupled to a rotor of a motor, wherein the position of the first rotary position target corresponds to a unique position of the steering shaft, and a first rotary position sensor configured to detect movement of the first rotary position target and send a sensor signal to a controller.

### BRIEF DESCRIPTION OF THE DRAWINGS

The disclosure will now be described in more detail with reference to the accompanying drawings, in which:

FIG. 1 is a perspective view of a steer-by-wire assembly according to an example;

FIG. 2 is a cross-sectional view of the steer-by-wire assembly according to an example;

FIG. 3 is an exploded perspective view of an absolute position sensor assembly according to an example;

FIG. 4 is a side cross-sectional view of an absolute position sensor assembly according to an example;

FIG. 5 is a front cross-sectional view of an absolute position sensor assembly according to another example;

FIG. 6 is a partial perspective view of an absolute position sensor assembly according to yet another example;

FIG. 7 is a front cross-sectional view of an absolute position sensor assembly according to another example;

FIG. 8 is a schematic diagram of a steer-by-wire assembly according to an example;

FIG. 9 is a flow diagram of a method of the steer-by-wire assembly according to an example; and

FIG. 10 is another cross-sectional view of an absolute position sensor assembly according to another example.

### DETAILED DESCRIPTION

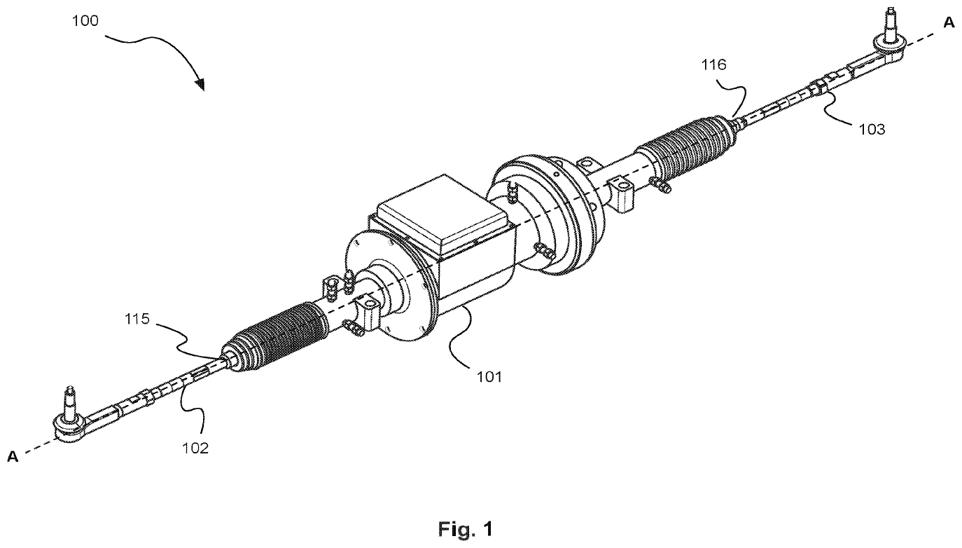

According to an example shown in FIG. 1, a steer-by-wire assembly 100 includes a housing 101, a first tie rod 102, a second tie rod 103, a steering shaft 114, a motor assembly 142, and an absolute position sensor assembly 125. FIG. 1 shows a perspective view of the steer-by-wire assembly 100. The housing 101 is mountable to a vehicle chassis and supports the various components of the steer-by-wire assembly 100.

In one example, the steer-by-wire assembly 100 is configured to provide precise and reliable control of the steering system in a vehicle. The steer-by-wire assembly 100 includes various components that work together to convert the rotational motion of a motor into linear motion of a steering shaft 114, which in turn controls the steering angle of the vehicle's wheels. The steer-by-wire assembly 100 offers several advantages over traditional mechanical steering systems, such as reduced complexity, improved responsiveness, and enhanced safety features.

In some examples, the steer-by-wire assembly 100 includes a housing 101 that supports and protects the various components of the steer-by-wire assembly 100. The housing 101 may be mountable to a vehicle chassis, providing a stable and secure platform for the steer-by-wire assembly 100. The housing 101 may be made of a durable material, such as metal or a high-strength polymer, to withstand the stresses and vibrations encountered during vehicle operation.

The steer-by-wire assembly 100 also includes a first tie rod 102 and a second tie rod 103, which are connected to the steering shaft 114 via first and second tie rod couplings 115, 116, respectively. In some examples, the first and second tie rod couplings 115, 116 can be spherical joints. The first and second tie rods 102, 103 transmit the linear motion of the steering shaft 114 to the vehicle's wheels, allowing for precise control of the steering angle. The first and second tie rods 102, 103 may be made of a strong and lightweight material, such as steel or aluminium, to ensure reliable performance and minimize the overall weight of the assembly.

The first tie rod 102 is connected to a first tie rod coupling 115 at a first steering shaft end 112 of the steering shaft 114. Similarly, the second tie rod 103 is connected to a second tie rod coupling 116 at a second steering shaft end 113 of the steering shaft 114. The steering shaft 114 extends along a longitudinal axis 104 and includes a threaded portion 120 that engages with a screw actuator 117.

In some examples, the housing 101 of the steer-by-wire assembly 100 is designed to be easily mountable to a vehicle chassis (not shown). This allows for straightforward integration of the steer-by-wire assembly 100 into a vehicle's steering system, reducing the complexity and time required for installation. The housing 101 may include mounting points or brackets (bracket) that facilitate secure attachment to the chassis, ensuring proper alignment and stability during operation.

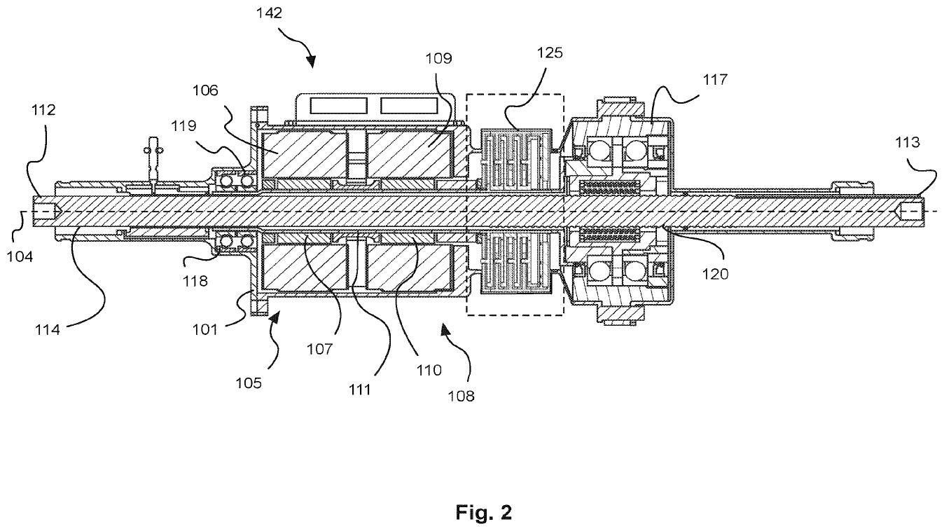

Turning to FIG. 2, the steer-by-wire assembly 100 will be discussed in more detail. FIG. 2 shows a cross-sectional drawing of the steer-by-wire assembly 100.

In one example, the steer-by-wire assembly 100 includes a steering shaft 114 that extends along a longitudinal axis 104. The steering shaft 114 is configured to move longitudinally in response to the rotation of a screw actuator 117, which engages a threaded portion 120 on the steering shaft 114. The screw actuator 117 may be a ball screw actuator or a roller screw actuator, both of which provide high efficiency and precision in converting the rotational motion of a motor into linear motion of the steering shaft 114. In other examples, any suitable screw actuator 117 can be used to transmit the rotational movement from the motor assembly 142 into linear movement of the steering shaft 114.

In some examples, the screw actuator 117 engages the threaded portion 120 of the steering shaft 114 to allow for linear movement of the steering shaft 114 along the longitudinal axis 104. The engagement between the screw actuator 117 and the threaded portion 120 ensures a secure and reliable connection, allowing for precise control of the position of the steering shaft 114 and, in turn, the steering angle of the vehicle's wheels.

In one example, the rotation of the screw actuator 117 causes the steering shaft 114 to move linearly along the longitudinal axis 104. This linear movement of the steering shaft 114 is transmitted to the vehicle's wheels via the first and second tie rods 102, 103, allowing for precise control of the steering angle. The range of movement of the steering shaft 114 may be defined by a predetermined number of rotations of the rotor carrier sleeve 111, which in turn corresponds to a range of movement from a first wheel lock position to a second wheel lock position.

The motor assembly 142 will now be discussed in more detail with respect to FIGS. 1 and 2.

The motor assembly 142 provides rotation to the screw actuator 117 to move the steering shaft 114 along the longitudinal axis 104. The motor assembly 142 includes a first motor 105 having a first stator 106 and a first rotor 107. The first stator 106 is fixed with respect to the housing 101, while the first rotor 107 is coupled to a rotor carrier sleeve 111.

In some examples, the steer-by-wire assembly 100 includes a motor assembly 142 that provides rotation to the screw actuator 117, enabling the linear movement of the steering shaft 114 along the longitudinal axis 104. The motor assembly 142 may include a first motor 105 having a first stator 106 and a first rotor 107, as well as an optional second motor 108 having a second stator 109 and a second rotor 110. The first and second motors 105, 108 may be configured to provide additional rotation or an alternative source of rotation to the screw actuator 117, ensuring smooth and precise control of the position of the steering shaft 114.

The second stator 109 is fixed with respect to the housing 101, while the second rotor 110 is coupled to the rotor carrier sleeve 111. The second motor 108 provides additional rotation to the screw actuator 117 to move the steering shaft 114 along the longitudinal axis 104.

The motor assembly 142 is coupled to a rotor carrier sleeve 111, which is connected between the rotor of the motor and the screw actuator 117. The rotor carrier sleeve 111 is configured to rotate about the longitudinal axis 104 of the steering shaft 114, transmitting the rotation from the first and/or second motor 105, 108 to the screw actuator 117. The rotor carrier sleeve 111 may be rotatably mounted to the housing 101 by a first carrier sleeve bearing 118 and a second carrier sleeve bearing 119, ensuring smooth and reliable operation.

Whilst the examples as shown in the accompanying Figures, shows the steer-by-wire assembly 100 with a first motor 105 and a second motor 108, in some examples there is only a single first motor 105 provided. A preferable example is a steer-by-wire assembly 100 with a first and second motor 105, 108 such that additional redundancy is provided if one of the first or second motor 105, 108 fails. Nevertheless, in some other examples there are any number of motors e.g., one, two, three etc.

The rotor carrier sleeve 111 is connected between the rotor of the motor and the screw actuator 117 and is configured to rotate about the longitudinal axis 104 of the steering shaft 114. The rotor carrier sleeve 111 is rotatably mounted to the housing 101 by a first carrier sleeve bearing 118 and a second carrier sleeve bearing 119.

The screw actuator 117 is rotatably mounted around the steering shaft 114 and engages the threaded portion 120 on the steering shaft 114, translating motor rotation into linear movement of the steering shaft 114. The screw actuator 117 can be a ball screw actuator or a roller screw actuator.

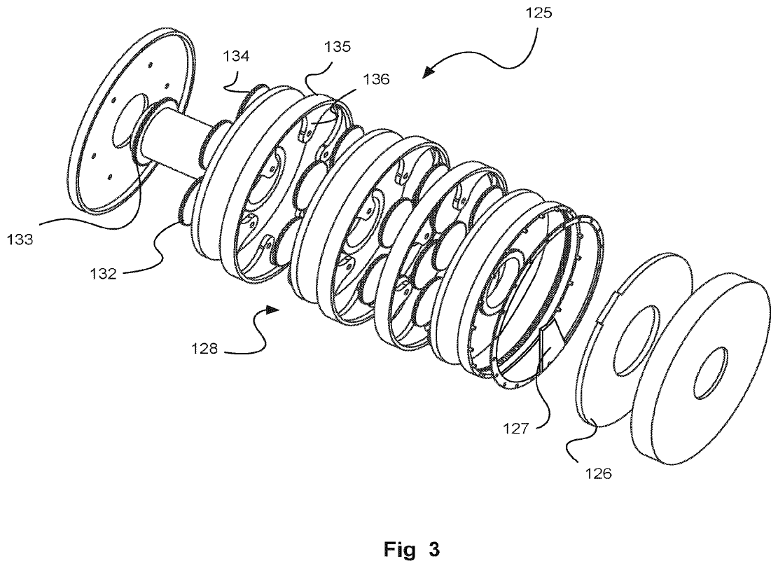

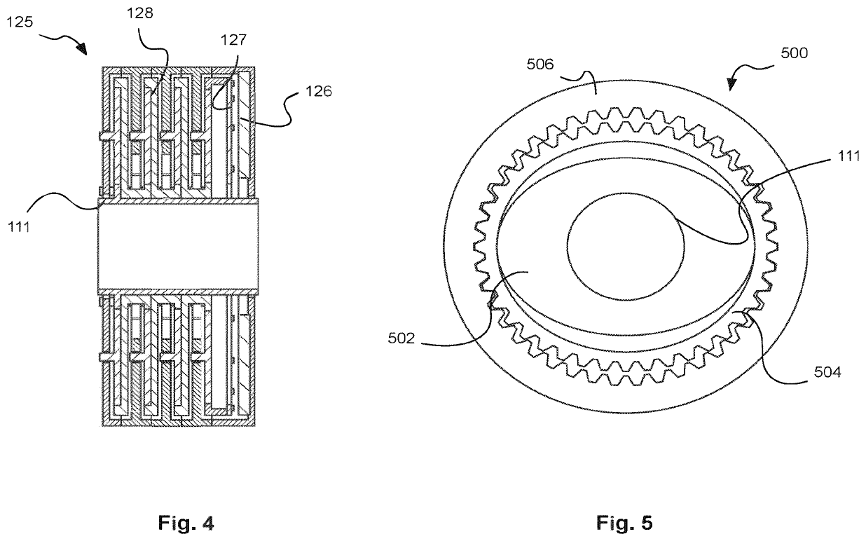

The assembly 100 may also include an absolute position sensor assembly 125 that accurately determines the position of the steering shaft 114, ensuring precise control of the vehicle's steering angle. The absolute position sensor assembly 125 will now be discussed in more detail with reference to FIG. 3, and 4. FIG. 3 shows a perspective exploded view of the absolute position sensor assembly 125. FIG. 4 shows a cross-sectional view of the absolute position sensor assembly 125.

In one example, the absolute position sensor assembly 125 is a component of the steer-by-wire assembly 100. The absolute position sensor assembly 125 is configured to accurately determine the position of the steering shaft 114. The absolute position sensor assembly 125 comprises a first rotary position target 127 and a first rotary position sensor 126. The first rotary position target 127 is coupled to the rotor carrier sleeve 111 such that the first rotary position target 127 moves when the rotor carrier sleeve moves 111. In this way, the rotary movement of the first rotor 107 or the second rotor 110 is transmitted to the first rotary position target 127. The first rotary position sensor 126 is configured to detect relative movement of the first rotary position target 127 with respect to the first rotary position sensor 126 and send a sensor signal to a controller 121. The first rotary position target 127 is optionally circumferentially arranged around the rotor carrier sleeve 111, and its position corresponds to a unique position of the steering shaft 114. This unique position correspondence ensures that the position of the steering shaft 114 and thus the angle of the road wheels is known at all times. This includes incidences where a power loss to the steer-by-wire assembly 100 or the vehicle, or movement of the steering wheels (for example during a routine service event) when the steer-by-wire assembly 100 is not electrically powered. The examples described herein avoid scenarios which would result in ambiguity regarding the actual position of the road wheels.

The first rotary position sensor 126 is configured to detect movement of the first rotary position target 127 and send a sensor signal to a controller 121. The controller 121 processes the sensor signal to determine the absolute position of the steering shaft 114. This accurate determination of the steering shaft 114 position enables precise control of the vehicle's steering, which enhances the safety and performance of the vehicle.

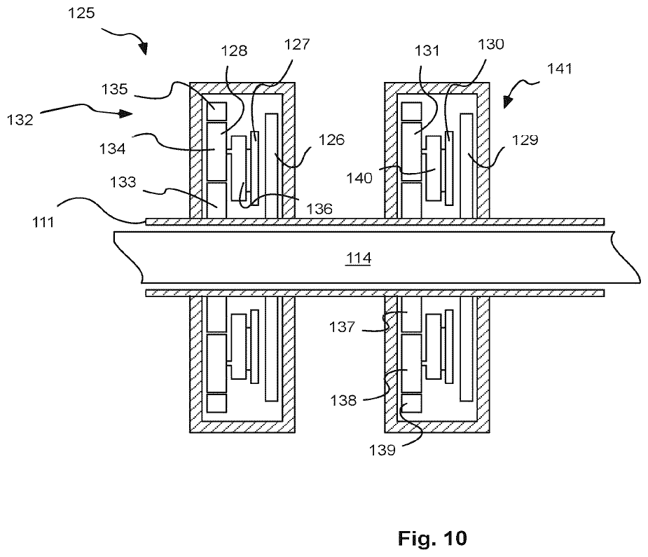

As shown in FIG. 7 or 10, in some examples, the absolute position sensor assembly 125 may further comprise a second rotary position target 130 and a second rotary position sensor 129. The sensor signal which is generated from the second rotary position sensor 129 can be used separately from or together with the sensor signal generated from the first rotary position sensor 126. If the sensor signal that is generated from the second rotary position sensor 129 is independent, then the second rotary position sensor 129 is identical to the first rotary position sensor 126 and is provided for redundancy purposes in case the first rotary position sensor 126 fails. In the example where the signals from the first rotary position sensor 126 and the second rotary position sensor 129 are used together, the arrangement of the absolute position sensor assembly 125 can be simpler and more compact. The second rotary position target 130 is also optionally circumferentially arranged around the rotor carrier sleeve 111. The position of the second rotary position target 130, together with the position of the first rotary position target 127, corresponds to a unique position of the steering shaft 114. This combined unique position determination provides an additional layer of accuracy and redundancy, further enhancing the precision and reliability of the steer-by-wire assembly 100.

Similar to the first rotary position sensor 126, the second rotary position sensor 129 is configured to detect movement of the second rotary position target 130 and send a sensor signal to the controller 121. The controller 121 processes the sensor signals from both the first rotary position sensor 126 and the second rotary position sensor 129 to determine the absolute position of the steering shaft 114 with even greater accuracy.

Accordingly, in some examples the absolute position of the steering shaft 114 is determined using a single first rotary position sensor 126. In other examples, the absolute position of the steering shaft 114 is determined using a plurality of sensors e.g., the first rotary position sensor 126 and the second rotary position sensor 129. These different examples of the absolute position sensor assembly 125 will be discussed in more detail below.

In some examples, the absolute position sensor assembly 125 may also include a first sensor gearing 128. The first sensor gearing 128 is configured to rotatably engage the rotor carrier sleeve 111 and the first rotary position target 127, providing a gear reduction so that the first rotary position target 127 rotates less than the rotor carrier sleeve 111. This gear reduction mechanism allows for a more precise determination of the steering shaft 114 position, as it enables the first rotary position target 127 to rotate within a smaller angular range, thereby increasing the resolution of the position measurement.

In some examples, the gear reduction of the first sensor gearing 128 is such that the first rotary position target 127 rotates less than 360 degrees when the rotor carrier sleeve 111 rotates through the entire rotational range of movement of the rotor carrier sleeve 111 required to move the steering shaft 114 from the first wheel lock position to second wheel lock position. In some examples, the first rotary position target 127 is configured to rotate through an angular range of 0 degrees to 350 degrees, 0 degrees to 340 degrees, 0 degrees to 330 degrees, 0 degrees to 320 degrees, 0 degrees to 310 degrees, 0 degrees to 300 degrees, 0 degrees to 290 degrees, 0 degrees to 280 degrees, 0 degrees to 270 degrees, 0 degrees to 260 degrees, 0 degrees to 250 degrees, 0 degrees to 240 degrees, 0 degrees to 230 degrees etc. The first rotary position target 127 is configured to rotate through any angular range less than 360 degrees. This means that the angular position of the first rotary position target 127 is unique for any position of the steering shaft 114 from the first wheel lock position to second wheel lock position.

In some examples, the absolute position sensor assembly 125 may also optionally include a second sensor gearing 131. The second sensor gearing 131 is configured to rotatably engage the rotor carrier sleeve 111 and the second rotary position target 130, providing a gear reduction so that the first rotary position target 127 rotates less than the rotor carrier sleeve 111.

The second sensor gearing 131, if present, is configured to rotatably engage the rotor carrier sleeve 111 and the second rotary position target 130, providing a gear reduction so that the second rotary position target 130 rotates optionally less than the rotor carrier sleeve 111. However, the sensor signals received from both the first rotary position sensor 126 and the second rotary position sensor 129 to determine the absolute position of the steering shaft 114. In this case the combination of the sensor signals from both the first rotary position sensor 126 and the second rotary position sensor 129 correspond to a unique position of the steering shaft 114 between the first wheel lock position to second wheel lock position. This will be discussed in more detail below. In some examples, the gearing of the second sensor gearing 131 is different from the gearing of the first sensor gearing 128, which further enhances the accuracy and redundancy of the absolute position determination.

In some examples, the first sensor gearing 128 and the second sensor gearing 131 may comprise various types of gears, such as an epicyclic gear arrangement 132, a harmonic gear arrangement 500, spur gears, bevel gears, a worm gear arrangement, gear racks, and pinion gears. Any other suitable gear mechanism can be used to couple the rotor carrier sleeve 111 to the first rotary position target 127 or the second rotary position target 130.

In the example as shown in FIG. 3, the first sensor gearing 128 comprises a first epicyclic gear arrangement 132 with a first sun gear 133 fixed with respect to the rotor carrier sleeve 111. The first sun gear 133 is configured to engage with a first plurality of planetary gears 134 which are mounted on a first carrier 136. The first planetary gears 134 engage with a first ring gear 135. FIG. 3 shows an optional series of first epicyclic gear arrangements 132 coupled together. By providing a plurality of first epicyclic gear arrangements 132, the gearing can be reduced in a small volume. This means that the radial size of the absolute position sensor assembly 125 can be kept small. FIG. 4 shows how the absolute position sensor assembly 125 provides a compact arrangement when assembled.

In some examples as shown in FIG. 10, the absolute position sensor assembly 125 may optionally comprise an epicyclic gear arrangement 132 with a single first sun gear 133, a single set of first planetary gears 134, and a single first ring gear 135. In some examples, the epicyclic gear arrangement 132 as shown in FIG. 3 is replaced with the epicyclic gear arrangement 132 as shown in FIG. 10 for the absolute position sensor assembly 125. In the arrangement as shown in FIG. 10, the second rotary position target 130 is also coupled to the rotor carrier sleeve 111 via an epicyclic gear arrangement 132. The second sensor gearing 131 comprises a second epicyclic gear arrangement 141 with a second sun gear 137 fixed with respect to the rotor carrier sleeve 111. The second sun gear 137 is configured to engage with a second plurality of planetary gears 138 which are mounted on a second carrier 140. The second planetary gears 138 engage with a second ring gear 139. FIG. 3 shows an optional series of connected first epicyclic gear arrangements 132

Accordingly, the largest diameter of the absolute position sensor assembly 125 is smaller than the largest diameter of the housing 101. This means that the absolute position sensor assembly 125 is compact and does not increase the overall size of the steer-by-wire assembly 100.

As discussed in reference to FIG. 3, the first sensor gearing 128 comprises an epicyclic gear arrangement 132. However, in other examples other mechanisms can be used to couple the rotor carrier sleeve 111 to the first rotary position target 127.

One such alternative arrangement is shown in FIG. 5. FIG. 5 shows a front cross-sectional view of part of the absolute position sensor assembly 125 wherein the first sensor gearing 128 comprises a harmonic gearing arrangement 500. The harmonic gearing arrangement 500 comprises a wave generator 502 coupled to the rotor carrier sleeve 111. The wave generator 502 engages the flexspline 504 which engages the circular spline 506. The circular spline 506 is connected to the first rotary position target 127 and causes rotation of the first rotary position target 127 with respect to the first rotary position sensor 126 when the rotor carrier sleeve 111 rotates. Similar to the epicyclic gear arrangement 132 as shown in FIG. 3, the harmonic gearing arrangement 500 reduces the gearing such that the first rotary position target 127 rotates less than 360 degrees. Furthermore, the epicyclic gear arrangement 132 as shown in FIG. 10 can be replaced with a harmonic gearing arrangement 500 for both the first and second sensor gearings 128, 131.

As discussed above, in one example, the controller 121 determines the absolute position of the steering shaft 114 based on the detected unique angular position of the first rotary position target 127 when only the signal from the first rotary position sensor 126 is used. However, in some examples, additionally the second rotary position sensor 129 is identical to the first rotary position sensor 126 and functions in the same way. In this way, the second rotary position sensor 129 can be used for additional sensor redundancy. In this example the second rotary position sensor 129 is not used together with the first rotary position sensor 126 for the Vernier principle. This configuration may be advantageous in situations where the second rotary position sensor 129 is not present or not functioning properly, as it still allows for accurate determination of the steering shaft 114 position using only the first rotary position sensor 126.

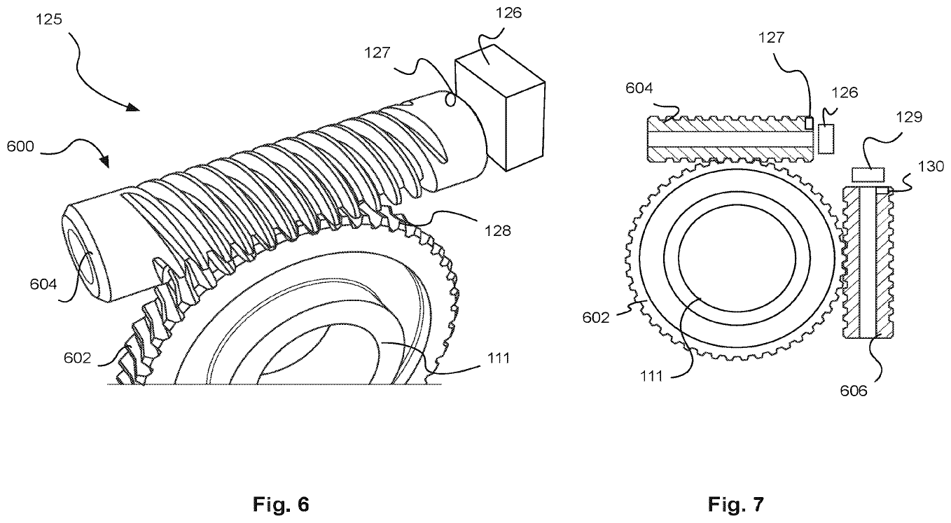

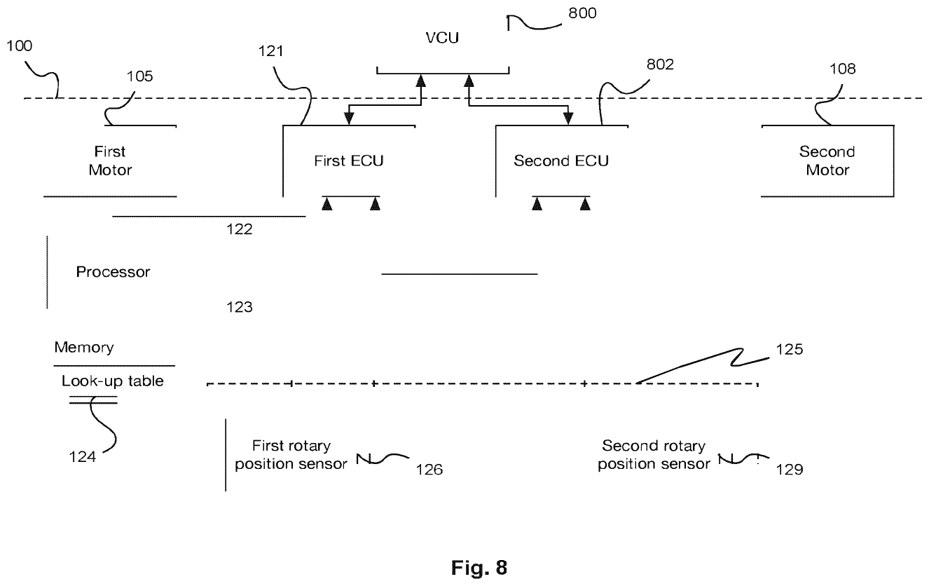

Another alternative to the gearing arrangement is shown in FIGS. 6 and 7. FIG. 6 shows a perspective view of the absolute position sensor assembly 125 wherein the first sensor gearing 128 comprises a worm gearing arrangement 600. In this case a worm-worm wheel 602 is fixed with respect to the rotor carrier sleeve 111 and circumferentially mounted thereabouts (partially shown in FIG. 6). The worm-worm wheel 602 meshes with a first worm gear 604. The first rotary position target 127 is mounted on the first worm gear 604 and rotates with respect to the first rotary position sensor 126 when the rotor carrier sleeve 111 rotates. In this case, the first rotary position target 127 is mounted close to the rotor carrier sleeve 111 but is not circumferentially arranged about the rotor carrier sleeve 111.

FIG. 7 shows an arrangement whereby both the first and second sensor gearings 128, 131 have been replaced with a worm gear arrangement 600 as described in reference to FIG. 6. In this case, the absolute position sensor assembly 125 comprises a second worm gear 606 which also meshes with the worm-worm wheel 602. In this case, the second rotary position target 130 is mounted on the second worm gear 606 and rotates with respect to the second rotary position sensor 129 when the rotor carrier sleeve 111 rotates. Similar to the other examples, the gear ratio of the first worm gear 604 is different from the second worm gear 606. In this case, the first rotary position target 127 and the second rotary position target 130 is mounted close to the rotor carrier sleeve 111 and together are circumferentially arranged about the rotor carrier sleeve 111.

The first sensor gearing 128 may comprise a first prime number of teeth, while the second sensor gearing 131 may comprise a second prime number of teeth, different from the first prime number of teeth. In some other examples the gear ratios of the first sensor gearing 128 and the second sensor gearing 131 may be both prime numbers. This configuration ensures that the first and second sensor gearings 128 and 131 have a unique engagement pattern in any position of the steering shaft 114. In some examples the total number of the rotations of the rotor carrier sleeve 111 required to move the steering shaft 114 from the first wheel lock position to second wheel lock position is less than the product of the gear ratios of the first sensor gearing 128 and the second sensor gearing 131. For example, in order to move the steering shaft 114 from first wheel lock position to second wheel lock position may require 32 revolutions of the rotor carrier sleeve 111. The gear ratios of the first sensor gearing 128 and the second sensor gearing 131 may respectively be 7:1 and 5:1. In other examples the gear ratios of the first sensor gearing 128 and the second sensor gearing 131 may be selected from 2:1, 3:1. 5:1, 7:1, 11:1, 13:1, 17:1, 19:1, 23:1, 29:1, 31:1, 37:1, 41:1, 43:1, 47:1, 53:1, etc.. Advantageously by using the first prime number of teeth and the second prime number of teeth, this makes sure that the absolute position sensor assembly 125 output values (e.g. the combination of the output from the first rotary position sensor 126 and the output from the second rotary position sensor 129) are always unique. This means for any combination of outputs from the first rotary position sensor 126 and the second rotary position sensor 129 there is no single point between wheel lock to wheel lock position at which the combination of outputs would be the same. This enables absolute position determination of the steering shaft 114 and the wheels.

As mentioned above, the sensor signals from the first and/or the second rotary position sensors 126, 129 as used to determine the absolute position of the steering shaft 114. In one example, the steer-by-wire assembly 100 includes a controller 121 and memory 123 components that are configured to process sensor signals and determine the absolute position of the steering shaft 114. The controller 121 may be a first electronic control unit (ECU) 121 that sends control instructions to the motor assembly 142 and receives instructions from a vehicle control unit (VCU) 800. The controller 121 may comprise a microprocessor 122 and memory 123 for storing data and executing instructions. In another example, a second ECU 802 is additionally or alternatively configured to process sensor signals and determine the absolute position of the steering shaft 114. If both the first ECU 121 and the second ECU 802 are able to determine the absolute position of the steering shaft 114, this increases the redundancy of the overall system.

In some examples, the microprocessor 122 is responsible for executing instructions and processing data received from the first rotary position sensor 126 and/or the second rotary position sensor 129. The memory 123 may be any suitable type of memory 123, such as volatile or non-volatile memory 123, and may store various data and instructions required for the operation of the controller 121.

In one example, the memory 123 stores a look-up table 124 that contains relationship information of the absolute position of the steering shaft 114 and the first rotary position target 127 and/or the second rotary position target 130. The look-up table 124 may be pre-programmed or dynamically updated during the operation of the steer-by-wire assembly 100. The look-up table 124 allows the controller 121 to determine the absolute position of the steering shaft 114 based on the received sensor signals from the first rotary position sensor 126 and/or the second rotary position sensor 129.

The controller 121 is configured to determine the absolute position of the steering shaft 114 based on the received sensor signals from the first rotary position sensor 126 and/or the second rotary position sensor 129 using the look-up table 124 stored in memory 123. This enables accurate and reliable determination of the steering shaft 114 position, which is essential for the proper functioning of the steer-by-wire assembly 100.

As discussed in some examples, the controller 121 is configured to determine the absolute position of the steering shaft 114 based on a detected unique rotary position of both the first rotary position target 127 and the second rotary position target 130 using the Vernier principle when signals are received from both the first rotary position sensor 126 and the second rotary position sensor 129. The Vernier principle allows for increased accuracy and resolution in determining the absolute position of the steering shaft 114 by combining the unique positions of both the first and second rotary position targets 127 and 130. This configuration may be advantageous in situations where higher precision and accuracy are required for the operation of the steer-by-wire assembly 100.

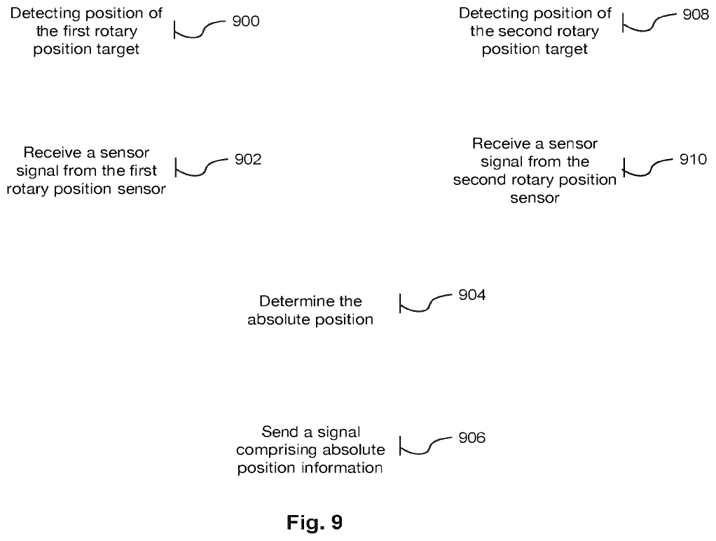

The method of determining the absolute position of a steering shaft 114 in a steer-by-wire assembly 100 will now be discussed in more detail with reference to FIG. 9. This method allows for accurate and reliable determination of the steering shaft 114 position.

In one example, which describes the method used for the first rotary position sensor 126 as discussed in reference to FIGS. 1 to 6, the method includes detecting the position of the first rotary position target 127 with the first rotary position sensor 126 as shown in step 900. In this case, the first rotary position sensor 126 is an absolute position sensor as described above. The first rotary position target 127 is circumferentially arranged around the rotor carrier sleeve 111, and its position corresponds to a unique position of the steering shaft 114. By detecting the position of the first rotary position target 127, the method can accurately determine the absolute position of the steering shaft 114. The first rotary position sensor 126 on detecting relative movement of the first rotary position target 127 with respect to the first rotary position sensor 126 generates a sensor signal. The controller 121 receives the sensor signal from the first rotary position sensor 126 as shown in step 902.

The controller 121 is configured to determine the absolute position of the steering shaft 114 as shown in step 904. In step 904, the controller 121 determines the absolute position based on the received sensor signal from the first rotary position sensor 126 using a look-up table 124 stored in memory 123. The look-up table 124 stores the relationship information of the absolute position of the steering shaft 114 and the first rotary position target 127. By using the look-up table 124, the method can quickly and accurately determine the absolute position of the steering shaft 114 based on the detected sensor signal, which is essential for the proper functioning of the steer-by-wire system. The look-up table 124 may optionally comprise a list of position parameters of the steering shaft 114, e.g., a displacement of the steering shaft 114 from a centre position which corresponds to an angular position of the first rotary position target 127. Alternatively, the look-up table 124 may be replaced with a position calculation algorithm which calculates the position of the steering shaft 114 based on the angular position of the first rotary position target 127. In this case, the controller 121 is configured to dynamically determine the position of the steering shaft 114.

Once the absolute position of the steering shaft 114 is determined, the controller 121 is configured to optionally send a signal comprising the absolute position information of the steering shaft 114 as shown in step 906. The signal may be sent from the controller 121 to another component such as the second ECU 802 or the VCU 800 or any other component in the steer-by-wire assembly 100 or in the vehicle. In this example, the method for the first rotary position sensor 126 being used as an absolute position sensor, only steps 900, 902, 904 and 906 are used.

In some examples, the method may also include detecting the position of the second rotary position target 130 with the second rotary position sensor 129 as shown in step 908. In this case, the method is being described with respect to the examples as described in reference to FIGS. 7 and 10. That is the combined outputs from the first rotary position sensor 126 and the second rotary position sensor 129 are used to determine the absolute position using the Vernier principle. The second rotary position target 130 is also circumferentially arranged around the rotor carrier sleeve 111, and its position, together with the position of the first rotary position target 127, corresponds to a unique position of the steering shaft 114. The second rotary position sensor 129 on detecting relative movement of the second rotary position target 130 with respect to the second rotary position sensor 129 generates a sensor signal. The controller 121 receives the sensor signal from the second rotary position sensor 129 as shown in step 908.

When signals are received from both the first rotary position sensor 126 and the second rotary position sensor 129 as shown in steps 902 and 910, the controller 121 is further configured to determine the absolute position of the steering shaft 114 as shown in step 904.

Here step 904 is the same as previously discussed with the exception that the absolute position of the steering shaft 114 is determined based on a detected unique rotary position of both the first rotary position target 127 and the second rotary position target 130. In this way the controller 121 is configured to use the Vernier principle to determine the absolute position of the steering shaft 114 from the angular position of the first and second rotary position targets 127, 130. The Vernier principle allows for accurate determination of the absolute position of the steering shaft 114 by combining the detected unique combined position of both the first and second rotary position targets. That is absolute position of the steering shaft 114 is determined throughout the complete motion of the screw actuator 117 of the steering system from the first wheel lock position to the second wheel lock position. In this example, the method which uses the first rotary position sensor 126 and the second rotary position sensor 129 includes steps 900, 902, 904, 906, 908 and 910 as shown in FIG. 9.

Thereafter, the controller 121 can proceed to step 906 as before.

The absolute position sensor assembly 125 in the steer-by-wire assembly 100 may comprise various types of first and/or second rotary position sensors 126, 129 and first and/or second rotary position targets 127, 130, depending on the specific application requirements and desired performance characteristics.

In some examples, the first rotary position sensor 126 and/or the second rotary position sensor 129 may be selected from the group consisting of an optical encoder, a magnetic encoder, an inductive encoder, a capacitive encoder, a Hall effect sensor, a resolver, a potentiometer encoder, and a cam follower. These different sensor technologies offer various advantages in terms of accuracy, resolution, robustness, and cost, allowing the steer-by-wire assembly 100 to be tailored to the specific needs of the application.

In some examples, the first rotary position target 127 and/or the second rotary position target 130 may be selected from the group consisting of a magnetic encoder, a patterned disc, a coded disc, a grating disc, a retroreflector disc, a slotted disc, and a Vernier scale disc. These different target configurations provide a range of options for encoding the unique position of the steering shaft 114, enabling the absolute position sensor assembly 125 to achieve the desired level of precision and reliability in determining the steering shaft 114 position.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A hand wheel actuator for a steer-by-wire steering assembly comprising:
a steering column having a steering column shaft;
a steering wheel armature rotatable with respect to the steering column having a rim;
at least one inner spoke mounted to the steering column shaft and rotatable from a first spoke position to a second spoke position; and
an inner ring connected to the at least one inner spoke and rotatable about a steering column axis, and at least one outer spoke is connected between the inner ring and the rim.

2. The hand wheel actuator according to claim 1, wherein the steering wheel armature is rotatable less than 180 degrees in a first rotation direction and a second rotation direction from a central position.

3. The hand wheel actuator according to claim 2, wherein the range of motion of the steering wheel armature is between 90 degrees and 170 degrees in the first rotation direction and the second rotation direction.

4. The hand wheel actuator according to claim 1, further comprising an electrical component protruding through the steering wheel armature and electrically connected to an electrical and data connection and wherein the electrical component is positioned outside the range of movement of the at least one spoke.

5. The hand wheel actuator according to claim 4, wherein the electrical component is selected from the group consisting of a motor, an encoder, a sensor, control circuitry, a communication module, error detection and correction circuitry, diagnostic and monitoring circuitry, safety features, an airbag, and a display screen.

6. The hand wheel actuator according to claim 1, further comprising a component housing mounted fixed with respect to the steering column and configured to protect the electrical component mounted inside the component housing.

7. The hand wheel actuator according to claim 6, further comprising a first spoke end stop configured to engage the at least one inner spoke when the spoke is in the first spoke position and prevent further movement of the at least one inner spoke in the first rotation direction.

8. The hand wheel actuator according to claim 6, further comprising a second spoke end stop configured to engage the at least one spoke when the spoke is in the second spoke position and prevent further movement of the at least one spoke in the second rotation direction.

9. The hand wheel actuator according to claim 1, further comprising a steer-by-wire steering actuator configured to translate electronic signals received from the steering wheel armature into physical steering movements of a vehicle.

10. The hand wheel actuator according to claim 1, further comprising an electronic control unit connected to the electrical and data connection.

11. The hand wheel actuator according to claim 1, further comprising a steering angle sensor electrically connected to the electronic control unit and configured to measure the angle of the steering column shaft and the direction in which it is turning.

12. The hand wheel actuator according to claim 11, wherein the steering angle sensor is selected from the group consisting of a magnetic field steering angle sensor, an optical steering angle sensor, an ultrasonic steering angle sensor, a capacitive steering angle sensor, a piezoresistive steering angle sensor, a fiber optic steering angle sensor, and a rotary transformer steering angle sensor.

13. The hand wheel actuator according to claim 1, wherein the at least one inner spoke is mounted in the middle of the steering wheel armature.

14. The hand wheel actuator according to claim 1, wherein the inner ring is fixed with respect to the at least one inner spoke and allows any outer spoke configuration.

15. A steering wheel armature assembly for a handwheel actuator comprising:
a steering wheel armature having a rim and at least one inner spoke mountable to a steering column shaft wherein the at least one spoke is rotatable from a first spoke position to a second spoke position when mounted to the steering column shaft; and
an inner ring connected to the at least one spoke and rotatable about a steering column axis; and
at least one outer spoke is connected between the inner ring and the rim.
